(19) United States
(12) Patent Application Publication
(10) Pub. No.: US 2025/0077084 A1
(43) Pub. Date: Mar. 6, 2025

(54) WRITE PROCESSING USING QUEUE AND THREAD IDENTIFICATION

(71) Applicant: Micron Technology, Inc., Boise, ID (US)

(72) Inventor: Luca Bert, San Jose, CA (US)

(21) Appl. No.: 18/776,341

(22) Filed: Jul. 18, 2024

Related U.S. Application Data
(60) Provisional application No. 63/536,818, filed on Sep. 6, 2023.

(51) Int. Cl. G06F 3/06

(52) U.S. Cl. CPC G06F 3/0613; G06F 3/0659; G06F 3/0673

(57) ABSTRACT

Various embodiments provide for processing write requests on a memory system based on queue identifiers and thread identification associated with the write requests. In particular, various embodiments can leverage queue identifiers and memory address information included in write requests to separate, associate those write request to threads (e.g., virtual thread) tracked by the memory system, and coalesce multiple write requests associated with a single thread into a single (larger) write to a sequence of blocks.

### PRIORITY APPLICATION

This application claims the benefit of priority to U.S. Provisional Application Ser. No. 63/536,818, filed Sep. 6, 2023, which is incorporated herein by reference in its entirety.

### TECHNICAL FIELD

Example embodiments of the disclosure relate generally to memory devices and, more specifically, to processing write requests on a memory system based on queue identifiers and thread identification associated with the write requests.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 is a diagram illustrating an example architecture of a host system and a memory sub-system, in accordance with some embodiments of the present disclosure.

FIG. 3 illustrates an example of processing write requests of an example request data stream, in accordance with some embodiments of the present disclosure.

FIGS. 4 and 5 are flow diagrams of example methods for processing write requests on a memory system based on queue identifiers and thread identification associated with the write requests, in accordance with some embodiments of the present disclosure.

FIG. 6 is a block diagram of an example computer system in which embodiments of the present disclosure may operate.

### DETAILED DESCRIPTION

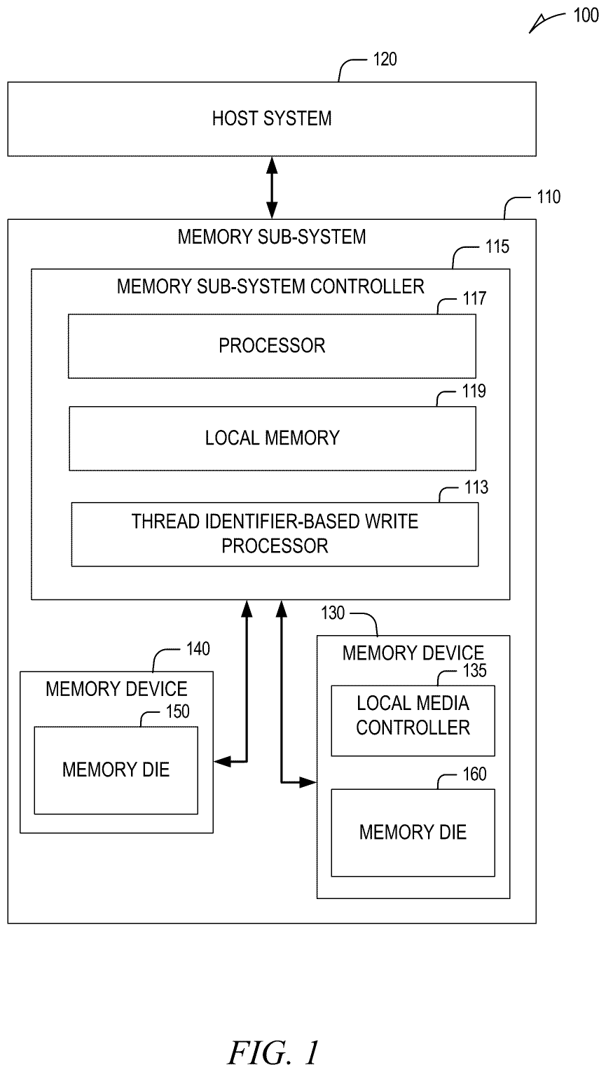

Aspects of the present disclosure are directed to processing write requests on a memory system (e.g., a memory sub-system) based on queue identifiers and thread identification associated with the write requests. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

In general, garbage collection (GC) comprises an operation to manage memory utilization in a NAND-type memory device. When free storage space in the NAND-type memory device gets low, GC can recover free storage space on the NAND-type memory device to allow for new host data to be written. During GC, a block of the NAND-type memory device that contains pages (or sections of pages) with valid data and pages with stale/invalid data (e.g., garbage) is read. Pages (or section of pages) of the block with the valid data are preserved, by writing the valid data to a free (e.g., a fresh or erased) block of the NAND-type memory device at a new physical memory location (thereby relocating the valid data to the new location). Additionally, the logical block address (LBA) for the valid data is updated with the new physical memory location. The free block can be selected from a free block pool. Pages with stale/invalid data are marked for deletion and remain in the (old) block. After all valid data is relocated from the old block, the entire old block (that comprises pages with the stale/invalid data) is erased, and the erased block can be added to the free block pool and used for a new incoming data write. Such data written to pages and block erasure can lead to write amplification (WA). A numerical WA metric can be determined using a ratio of the amount of data physically written to the NAND-type memory (e.g., physical writes) to the amount of data a host system originally intended to write (e.g., write requests from a host system). The actual physical writes are generally larger than the write requests from the host system, resulting in a WA metric greater than one.

A memory device can be a non-volatile memory device. A non-volatile memory device is a package of one or more die. Each die can be comprised of one or more planes. For some types of non-volatile memory devices (e.g., NOT-AND (NAND)-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Certain memory devices, such as NAND-type memory devices, comprise one or more blocks, (e.g., multiple blocks) with each of those blocks comprising multiple memory cells. For instance, a memory device can comprise multiple pages (also referred as wordlines), with each page comprising a subset of memory cells of the memory device. A memory device can comprise one or more cache blocks and one or more non-cache blocks, where data written to the memory device is first written to one or more cache blocks, which can facilitate faster write performance; data stored on the cache blocks can eventually be moved (e.g., copied) to one or more non-cache blocks at another time (e.g., performing a block compaction operation at a time when the memory device is idle), which can facilitate higher storage capacity on the memory device. A cache block can comprise a single-level cell (SLC) block that comprises multiple SLCs, and a non-cache block can comprise a multi-level cell (MLC) block that comprises multiple MLCs, a triple-level cell (TLC) block that comprise multiple TLCs, or a quad-level cell (QLC) block that comprises QLCs. Writing first to one or more SLCs blocks can be referred to as SLC write caching. Generally, writing data to such memory devices involves programming (by way of a program operation) the memory devices at the page level of a block, and erasing data from such memory devices involves erasing the memory devices at the block level (e.g., page level erasure of data is not possible).

For conventional memory devices that comprise NOT-AND (NAND) memory cells (hereafter referred to as NAND-type memory devices), writing and erasing sequentially generally leads to lower or reduced write amplification (e.g., a low write amplification factor (WAF)) and better data performance. While modern software on host systems (e.g., software applications, databases, and file systems) tend to read and write data sequentially with respect to a memory system (e.g., a memory sub-system coupled to a host system), when such software is executed by one or more multicore hardware processors of the host system, the sequentiality of data access request (e.g., read and write requests) to the memory system is usually lost. For instance, when modern software operates on one or more multicore hardware processors of a host system, a block layer of the host system typically divides work to be performed by each process (of the software) among two or more cores of a multicore hardware processor (e.g., in a way where work is uniformly divided across cores to achieve maximum throughput). While each core of a host system's hardware processor may still issue largely sequential data access requests to a memory system, the data access requests are usually intermingled (e.g., interleaved) with each other and appear random or pseudo-random from the perspective of the memory system. This can be due to data aggregation and request priority policy in a data link layer between the host system and the memory system. For instance, a memory system having a Non-Volatile Memory Express (NVMe) architecture is typically designed to have an out-of-order traffic handshake between the host system and a controller of the memory system for data performance reasons.

The architecture of conventional memory systems, such as those implemented by a NVMe standard, include multiple queues for processing data access requests (e.g., read and write requests) from host systems. For instance, a memory system based on a NVMe standard can comprise multiple pairs of queues, where each queue pair is associated with a different queue identifier (QID), and where each queue pair comprises a submission queue for incoming requests that need to be completed/processed and a completion queue for command requests already completed/processed by the memory system. As herein, a submission queue identifier (SQID) can refer to a submission queue of a given queue pair, and can be equal to the QID of the given queue pair. A QID can be included as a parameter (e.g., QID tag) in a data access request from a host system to a memory system, and can serve as a pointer to a submission queue on the memory system that is to receive the data access request. Generally, each core of a host system's hardware processor is individually associated with (e.g., assigned to, mapped to, attached to) a different QID (e.g., different queue pair on the memory system having a unique QID), and data access requests (e.g., read and write requests) from a given core are received and stored by a submission queue that has a queue identifier associated with the given core. Additionally, a given thread executing on a host system (e.g., of a software application or a database on the host system) tends to be started/run on the same core of the host system's hardware processor (e.g., threads on the host system tend to have core affinity). A given core of a host system's hardware processor can have multiple threads (e.g., four to five threads) that operate on and have affinity to the given core.

Accordingly, some memory systems process data access requests by using QID to infer patterns and sequentiality by mapping data access requests based on QIDs, where each QID can carry a relevant number of “segmented” sequential data streams. However, this means that there can be a sequential data pattern for some data access requests (e.g., data write requests), a discontinuity to a different sequential data pattern, and so on. This is because while QID-based data request (e.g., write) processing can leverage processor core affiliation, each core can run multiple threads, with each thread using its own sequential data pattern. Additionally, though threads are generally local to a core and are restarted on same core as much as possible, it is possible for a thread to be swapped out from a core and another thread to be swapped into the core (e.g., a host system can decide to move threads or data input/outputs (IOs) associated to threads to other cores any time the host system sees fit). Furthermore, thread identification information is not traditionally provided by host systems to memory systems (e.g., not included in data access requests from host systems to memory systems). As a result, traditional memory systems do not have a way to distinguish data access requests based on threads, and every thread core swap by a host system can insert a discontinuity to a sequential data pattern, which can negatively impact data storage placement and allocation.

Aspects of the present disclosure are directed to processing write requests on a memory system (e.g., a memory sub-system) based on queue identifiers and thread identification associated with the write requests. In particular, various embodiments can leverage queue identifiers and memory address information included in write requests to separate and associate those write request to threads (e.g., virtual thread) tracked by the memory system, and to do so despite a host system not providing actual thread information in association with data access requests (e.g., not including thread information in write requests). According to some embodiments, a memory system classifies write requests from a host system according to virtual threads that are tracked on the memory system and that attempt to mirror (or at least closely mirror) the identity of actual threads operating on the host system. In doing so, a memory system can leverage such virtual thread classification (on the memory system) to detect sequentiality of write requests (of those one or more virtual threads) and facilitate data storage locality/placement (on a memory media of the memory system) when writing data in association with a tracked virtual thread. Specifically, memory systems of some embodiments use a queue identifier of a submission queue and memory address information specified in write requests as a proxy for detecting sequentiality of write requests in association with one or more threads operating on a host system. This can represent an enhancement, and provide finer granularity of data storage locality/placement, over a memory system that only uses a queue identifier of a submission queue as a proxy for identifying one or more threads operating on a host system.

Overall, the data storage locality/placement facilitated by various embodiments described herein can result in larger sequential storage (e.g., organization) of data, associated with common virtual threads, on a memory system. In other words, various embodiments can organize data on a memory system conditioned upon virtual threads (e.g., virtual thread identifiers) and, in doing so, can protect data sequentially provided by submission queues. The sequential storage (e.g., organization) of data associated with common virtual threads can result in lower write amplification (which can lead to improved memory system endurance), higher performance of the memory system, higher performance per a unit of power (e.g., watt), or some combination thereof. Further, the data storage locality/placement facilitated by various embodiments described herein can enable a read ahead algorithm to be performed with more granularity (e.g., permit the algorithm to be more precise and selective). For instance, when SLC cache is de-staged (e.g., involving QLC block writes), when garbage collection is triggered (e.g., involving TLC block writes), or when read ahead is used, a memory system can select each stored data element associated with a given virtual thread (e.g., that has the same virtual thread identifier) and act on them based on the virtual thread (e.g., de-stage/garbage collect all stored data that share a given virtual thread identifier or perform prefetch on the last address of a given virtual thread identifier.

As used herein, a virtual thread can refer to a sequence of data access requests (e.g., write requests) associated with a thread being detected and tracked by a memory system based on queues identifier and memory address information received by the memory system via one or more write request from a host system. A virtual thread can be an entity detected and tracked by a memory system to facilitate tracking of data streams on the memory system in association with actual threads running on one or more cores of a hardware processor of the host system.

According to various embodiments, a given data stream (e.g., data write stream comprising write requests) is tracked in association with a given thread running on a host system by use of a virtual thread entity, which has a virtual thread identifier. A virtual thread identifier can refer to a given virtual thread detected by a memory system irrespective of which submission queue (SQID) it came through, its system name, or usage. A memory system can use a virtual thread identifier to track one or more virtual threads detected on a memory system based on queue identifiers and memory address information included in write requests received from a host system. For some embodiments, a memory system uses a thread-tracking data structure to store and track memory address information associated with different virtual threads detected by the memory system. The thread-tracking data structure can enable a memory system to track virtual threads and sequential data patterns (e.g., sequential write requests) in association with one or more different virtual threads, which can enable data storage locality/placement on a memory device of a memory system. The thread-tracking data structure can, for example, store a last memory address (e.g., LBA) received (by the memory system via a write request) with respect to each virtual thread tracked/detected (e.g., store the last memory address received in an entry associated with a virtual thread identifier for a virtual thread). For some embodiments, the thread-tracking data structure comprises an array (e.g., filter array) that is indexed by a virtual thread identifier (ID) and that is used to store a last memory address received by the memory system (e.g., via a write request) in association with a virtual thread identifier index. Additionally, for some embodiments, the array is first indexed by a submission queue identifier (SQID) and then further indexed by a virtual thread identifier (ID). The additional indexing by the SQID can facilitate a more efficient search of the array for detection of virtual threads and updating the array in response to write requests received from a host system via one or more submission queues of a memory system. Searching by indexing based SQID can be faster than performing a search without SQID (e.g., a random search based on all virtual threads identifiers).

During operation of a memory system, write requests can be received at a memory system, from a host system, via one or more submission queues of the memory system, where a submission queue associated with a specific queue identifier receives write requests having the same specific queue identifier. Each individual write request can comprise memory address information, such as an LBA, which can indicate a starting data storage location (e.g., start LBA) on the memory system where write data (e.g., payload data) from the individual write request will start being written. An individual write request can also comprise information indicating an amount (e.g., data write length) of data being written to the memory system, which can be used by the memory system to determine a last memory data storage location, and associated last memory address, to which the individual write request will write data. For an individual write request from a given submission queue, the memory system can search the thread-tracking data structure to determine (based on the memory address specified the individual write request) whether the memory address specified by the individual write request is associated with an existing virtual thread (e.g., virtual thread identifier) already being tracked by the memory system, or a new virtual thread encountered.

For instance, a memory system can determine a new virtual thread is detected when a current LBA is received from a host system in association with a write request and no existing virtual thread (virtual thread identifier) in the thread-tracking data structure has an LBA that precedes the current LBA. As a result, the memory system can generate (e.g., create) a new virtual thread identifier for the newly detected virtual thread. However, a memory system can determine a received write request is associated with an existing/previously-detected virtual thread when a current LBA of the received write request and an LBA stored (in the thread-tracking data structure) in association with the existing/previously-detected virtual thread is found to precede the current LBA of the received write request.

After a new virtual thread identifier or an existing virtual thread identifier is associated with a given write request, a memory system can cause the given write request to be processed based on the new/existing virtual thread identifier. For some embodiments, the memory system causes a given write request to be processed based on a new/existing virtual thread identifier by adding the given write request to a list of write requests associated with the new/existing virtual thread identifier. In this way, the memory system can cause write requests encountered to be parked for deferred processing (e.g., execution) at a later time by the memory system, thereby facilitating processing a single coalesced write request that covers multiple parked write requests. For instance, a memory system of an embodiment can park a write request for deferred processing (e.g., execution) by adding the write request to a specific list of parked write requests, where the specific list is associated with the specific virtual thread identifier (e.g., write_park [VTI] lists). For some embodiments, a memory system maintains a separate list of parked write requests for each virtual thread identifier detected and tracked by the memory system. When a monitored time (e.g., a timer) associated with a given list of parked write requests (for a VTI) has expired or when a number of write request in the given list of parked write requests surpasses a threshold number (e.g., a predetermined number of write requests, such as eight write requests), a memory system can cause at least some (e.g., all) of the write requests in the given list of parked write requests to start immediate processing (e.g., execution, executing, command merging, or staged execution) by the memory system. According to some embodiments, the expectation is that write requests in the given list of parked writer requests are highly sequential (e.g., based on affinity of detected virtual threads and individual virtual thread identifiers being) and so those write requests can be coalesced into a larger sequential write. For example, with respect to data access requests received and associated with one or more virtual threads, an embodiment described herein can cause a memory system to park write requests (e.g., write commands) for deferred processing and coalesce those write requests to single sequential write of a larger average size (e.g., ˜6000 logic block addresses (LBAs)) than not parking write requests for deferred execution (e.g., which can result in write requests of a smaller average size, such as 700 LBAs). With larger sequential writes based on lists of parked write requests, cursor granularity on a memory system can be rendered coarser, the workload (e.g., the number of number of I/O operations) performed during garbage collection can be reduced, and the performance of read ahead algorithms can be improved.

When a given write request associated with a given virtual thread identifier is processed, the given write request can be processed such that the virtual thread identifier is stored (e.g., as VTI-tags) on the memory in association with data (e.g., host or user data) written to a set of blocks on the memory system by the given write request. For instance, where data is written to a set of blocks in response to a write request associated with a virtual thread identifier (e.g., newly detected virtual thread or existing virtual thread), the data can include a virtual thread identifier (e.g., VTI) associated with the write request or metadata associated with the set of blocks can include the virtual thread identifier. In another instance, where data is written to a set of blocks in response to a write request associated with a virtual thread identifier, the virtual thread identifier (e.g., VTI) associated with the write request can be stored in a separate stream or separate storage area of the memory system in association with the set of blocks. Thereafter, when garbage collection is performed on one or more source blocks (e.g., of a source superblock) of the memory system, virtual thread identifiers stored in association with those blocks can be used to sequentially organize (e.g., sequentially write) data of common virtual thread identifiers in a set of destination blocks (e.g., of a destination superblock). In particular, a memory system of an embodiment can identify, in the one or more source blocks, a longest list of source memory units (e.g., pages or blocks) storing valid data and having common virtual thread identifiers, and performing garbage collection on blocks of the longest list. For instance, data can be migrated from one or more pages of the longest list to a destination superblock (e.g., to pages stripes thereof) until the destination superblock is filled or the list is exhausted. Thereafter, if the superblock is not full, a next longest list of source memory units (e.g., pages or blocks) storing valid data and having virtual thread identifiers is identified, and data can be migrated from one or more memory units of the next longest list to the destination superblock (e.g., to page stripes thereof) until the destination superblock is filled or the list is exhausted. This can be repeated until the destination superblock is filled. By performing garbage collection based on queue identifiers as described herein, various embodiments can increase the chances that when migrated valid data is eventually erased, the entire collection of destination memory units that received the migrated valid data (e.g., the entire destination superblock) will be erased at the same time, thereby resulting in improved performance and lower garbage collection overhead.

Eventually, a previously-detected/existing virtual thread (and its associated virtual thread identifier) can be pruned (e.g., removed or deleted) over time, such as based on a data space constraint (e.g., data size limit of array), a time constraint, or some combination thereof. After pruning a given virtual thread and its given virtual thread identifier, the given virtual thread identifier can be reused for a new virtual thread that is subsequently detected. For instance, pruning can be performed by limiting a total number of virtual thread identifiers tracked by the memory system (e.g., define that the array cannot keep more than a predetermined number of virtual thread identifiers), by evicting (e.g., using least recently used (LRU) algorithm or a similar eviction algorithm) inactive virtual thread identifiers after a time period, or a combination thereof. Another way to prune an existing virtual thread (and its associated virtual thread identifier) based on time comprises accepting as many new virtual thread identifiers as they come, and evicting them after being inactive after Y amount of time (which can be tracking time from a last write request for each virtual thread).

The following details an example approach for writing data on the memory system (e.g., to memory media thereof) based on queue identifiers and thread identification associated with the write requests. Assume a select write request is obtained from a submission queue three (SQID3) and comprising a current memory address of LBA24. A thread-tracking data structure (e.g., array) can be searched for an existing virtual thread associated with the select write request by searching for an existing virtual thread that has a memory address (LBA23) that precedes the current memory address (LBA24) of the select write request. For efficient search of the thread-tracking data structure, the thread-tracking data structure can be searched first based on the SQID3, and if no existing virtual thread is found, the thread-tracking data structure can be searched based on one or more different SQIDs (e.g., a predetermined number of remaining SQIDs, remaining SQIDs that are active, or a combination thereof). If an existing virtual thread is not found (e.g., not identified) in the thread-tracking data structure, the memory system can: determine that a new virtual thread is detected; can assign the newly detected virtual thread a virtual thread identifier (e.g., newly generated virtual thread identifier or an unused virtual thread identifier), such as virtual thread identifier four (VTI4); can add an entry (to the thread-tracking data structure) associated with the SQID3 (through which the select write request is received) and VTI4 that stores a last LBA being written to by the select write request (e.g., LBA24 if the select write request specifies only writing to a single logical block associated with LBA24); and can cause the select write request to be processed based on the new virtual thread. The processing the select write request based on the new virtual thread can comprise adding the select write request to a list of write requests (e.g., deferred or coalesced write requests) associated with the new virtual thread (VTI4). If an existing virtual thread is found (e.g., identified or there is a hit on an entry in the array) in the thread-tracking data structure, the memory system can: determine that the select write request is associated with the existing virtual thread (e.g., having a virtual thread identifier of VTI5); can cause the select write request to be processed based on the existing virtual thread; and can update an entry (of the thread-tracking data structure) associated with the existing virtual thread (e.g., entry associated with VTI5) to store a last LBA being written to by the select write request. For example, if the select write request specifies a memory address of LBA24 with a length of one, the entry associated with VTI5 can be stored with the LBA24. However, if the select write request specifies a memory address of LBA24 with a length of four, the entry associated with VTI5 can be stored with the LBA28 (with the next subsequent LBA being LBA29). The processing of the select write request based on the new virtual thread can comprise adding the select write request to a list of write requests (e.g., deferred or coalesced write requests) associated with the existing virtual thread (VTI5).

Data access request and command request are used interchangeably herein. As used herein, a data access request/command request can comprise a data access command for a memory system. Accordingly, a write request can comprise a write command for a memory system, and a read request can comprise a read command for a memory system.

As used herein, a superblock of a memory device (e.g., of a memory system) comprises a plurality (e.g., collection or grouping) of blocks of the memory device. For example, a superblock of a NAND-type memory device can comprise a plurality of blocks that share a same position in each plane in each NAND-type memory die of the NAND-type memory device.

Disclosed herein are some examples of processing write requests on a memory system based on queue identifiers and thread identification associated with the write requests, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, QLCs, and penta-level cells (PLCs), can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

Each of the memory devices 130, 140 include a memory die 150, 160. For some embodiments, each of the memory devices 130, 140 represents a memory device that comprises a printed circuit board, upon which its respective memory die 150, 160 is solder mounted.

The memory sub-system controller 115 includes a (virtual) thread identifier-based write processor 113 that enables or facilitates the memory sub-system controller 115 to process write requests based on queue identifiers and thread identification associated with the write requests as described herein. For some embodiments, the thread identifier-based write processor 113 can be part of a larger queue identifier-based request processor (not shown). Alternatively, some or all of the thread identifier-based write processor 113 is included by the local media controller 135, thereby enabling the local media controller 135 to enable or facilitate processing of write requests based on queue identifiers and thread identification associated with the write requests as described herein.

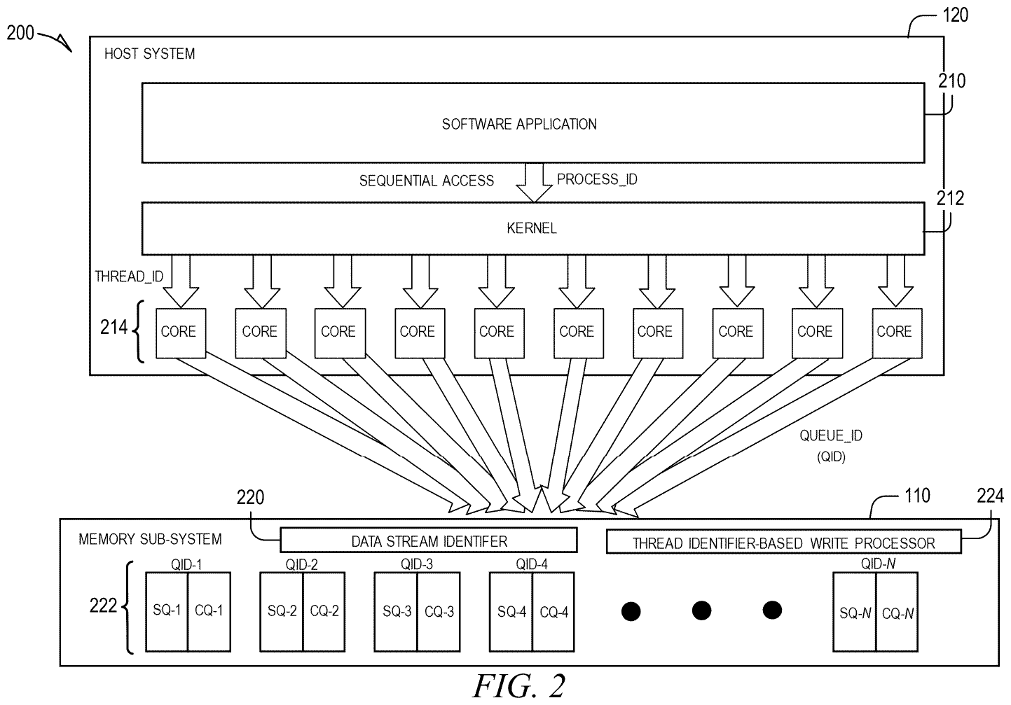

FIG. 2 is a diagram illustrating an example architecture 200 of the host system 120 and the memory sub-system 110 of FIG. 1, in accordance with some embodiments of the present disclosure. In the example architecture 200, the host system 120 comprises multiple hardware processor cores 214, a software application 210 operating on the multiple hardware processor cores 214, and a kernel 212 (e.g., of an operating system) operating on the multiple hardware processor cores 214. Additionally, in the example architecture 200, the memory sub-system 110 comprises a data stream identifier 220 (e.g., which is part of a queue identifier-based request processor) and multiple pairs of queues 222, which include queues pairs associated with queue identifier-1 (QID-1) through queue identifier-N(QID-N). The queue pair associated with queue identifier-1 (QID-1) comprises a submission queue 1 (SQ-1) and a completion queue (CQ-1), the queue pair associated with queue identifier-2 (QID-2) comprises a submission queue-2 (SQ-2) and a completion queue (CQ-2), the queue pair associated with queue identifier-3 (QID-3) comprises a submission queue-3 (SQ-3) and a completion queue (CQ-3), the queue pair associated with queue identifier-4 (QID-4) comprises a submission queue-4 (SQ-4) and a completion queue (CQ-4), and so on. During operation, the software application 210 can cause execution of processes (having process identifiers (PROCESS_IDs)) by the kernel 212, where one or more of the processes can involve generation of sequential data access requests. The kernel 212 can execute at least one of the processes by dividing the process into multiple threads (each having a thread identifier (THREAD_ID)) to be executed by the multiple hardware processor cores 214. Each of the threads can be assigned for execution by one of the multiple hardware processor cores 214 (e.g., according to core affinity), and execution of a thread by a given hardware processor core can cause the given hardware processor core to generate and issue one or more data access requests to the memory sub-system 110, where each generated/issued data access request includes a queue identifier (QID) of the given hardware processor core.

As data access requests are generated and issued by the multiple hardware processor cores 214, the data access requests from each hardware processor core can be interleaved with those generated and issued by one or more other hardware processor cores. Accordingly, the data access request received by the memory sub-system 110 can appear random or pseudo-random to the memory sub-system 110.

Upon receiving a given data access request, the memory sub-system 110 can use the data stream identifier 220 to determine a given queue identifier of the given data access request, and the memory sub-system 110 can cause the given data access request to be stored in a submission queue (e.g., stored to an entry added to the submission queue) of the queue pair (of the multiple pairs of queues 222) that corresponds to (e.g., matches) the given queue identifier. When the given data access request has been processed (e.g., executed) by the memory sub-system 110, the results of the given data access request can be stored (e.g., queued) to a completion queue (e.g., stored to an entry added to the completion queue) of the queue pair (of the multiple pairs of queues 222) that corresponds to (e.g., matches) the given queue identifier, from which the host system 120 can obtain (e.g., collect) the results.

The memory sub-system 110 comprises a (virtual) thread identifier-based write processor 224 that processes write requests based on queue identifiers and thread identification associated with the write requests, in accordance with some embodiments described herein. The thread identifier-based write processor 224 can scan one or more of submission queues 1 through N for command requests to be executed. The thread identifier-based write processor 224 can obtain, from a select submission queue of the submission queues 1 through N, a select write request that comprises a select memory address, where the select submission queue is associated with a select queue identifier. The thread identifier-based write processor 224 can search a virtual thread-tracking data structure (hereafter, thread-tracking data structure), based on the select memory address and the select queue identifier, for a select thread identifier associated with the select memory address. In response to finding the select thread identifier in the thread-tracking data structure, the thread identifier-based write processor 224 can cause the select write request to be processed based on the select thread identifier, and update the thread-tracking data structure based on the select write request, the select memory address, and the select thread identifier. In response to not finding the select thread identifier in the thread-tracking data structure, the thread identifier-based write processor 224 can generate a new thread identifier, cause the select write request to be performed based on the new thread identifier, and update the thread-tracking data structure based on the select write request, the select memory address, and the new thread identifier. Eventually, the thread identifier-based write processor 224 can determine whether the select thread identifier satisfies a set of pruning criteria and, in response to determining that the select thread identifier satisfies the set of pruning criteria, the thread identifier-based write processor 224 can update the thread-tracking data structure to remove one or more entries associated with the select thread identifier from the thread-tracking data structure.

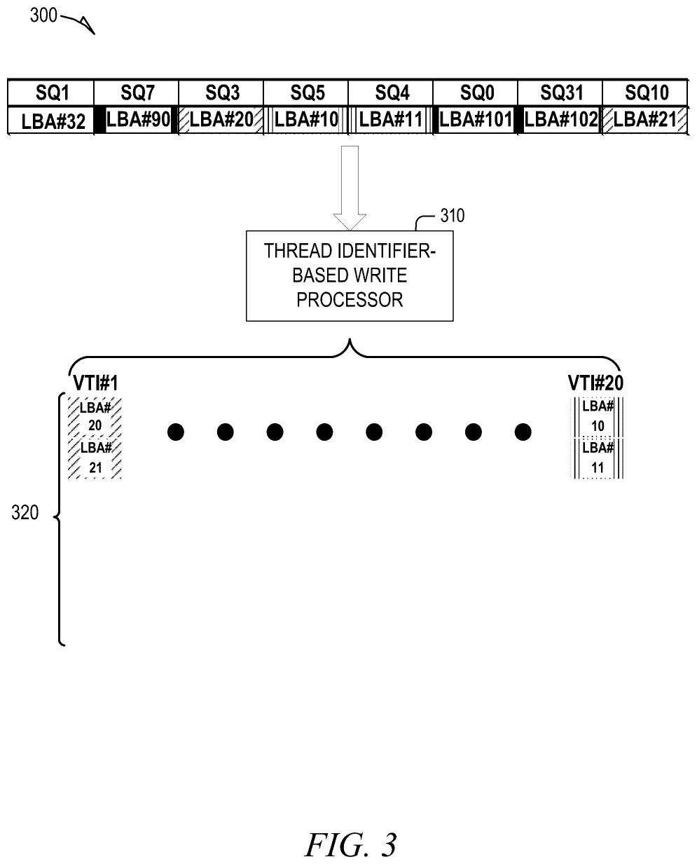

FIG. 3 illustrates an example of processing write requests of an example request data stream 300, in accordance with some embodiments of the present disclosure. In particular, the request data stream 300 comprises a random or pseudo random stream of requests (e.g., write requests and read requests) that each have a queue identifier (e.g., SQ1, SQ4, SQ3, SQ8, SQ0, and SQ31) associated with (e.g., corresponding to) a submission queue of a memory system, and that each have a respective LBA corresponding to a starting write location on a memory device (e.g., the memory device 130, 140) of a memory system (e.g., the memory sub-system 110). According to some embodiments, a memory system (e.g., the memory sub-system 110) includes a (virtual) thread identifier-based write processor 310, which can be configured to associate virtual thread identifiers on write requests from the request data stream 300 to filter/break down the request data stream 300 into sequential write streams 320, each of which represents collections (e.g., lists) of write requests that each have a common virtual thread identifier and that can be coalesced into one or more larger write requests. For example, as shown, write requests received by way of submission queues SQID3 and SQID10 can be associated with a common virtual thread identifier VTI #1 (based on their respective LBAs #20 and #21), and added to a collection (e.g., list) of write requests associated with VTI #1. Similarly, write requests received by way of submission queues SQID5 and SQID4 can be associated with a common virtual thread identifier VTI #20 (based on their respective LBAs #10 and #11), and added to a collection (e.g., list) of write requests associated with VTI #11. Depending on the embodiment, each of the sequential write streams 320 can be written (e.g., mapped) to a set of blocks of a memory device (e.g., 130, 140) of the memory system (e.g., the memory sub-system 110) using one or more different sequential data configurations (e.g., organizational arrangements). For instance, one of the sequential write streams 320 can be written to a NAND-type memory device of the memory system on a stripe (e.g., page stripe of a superblock) basis, a superblock basis, on a physical-to-logical (P2L) layer basis, or a 1/Nth deck basis (e.g., half block basis).

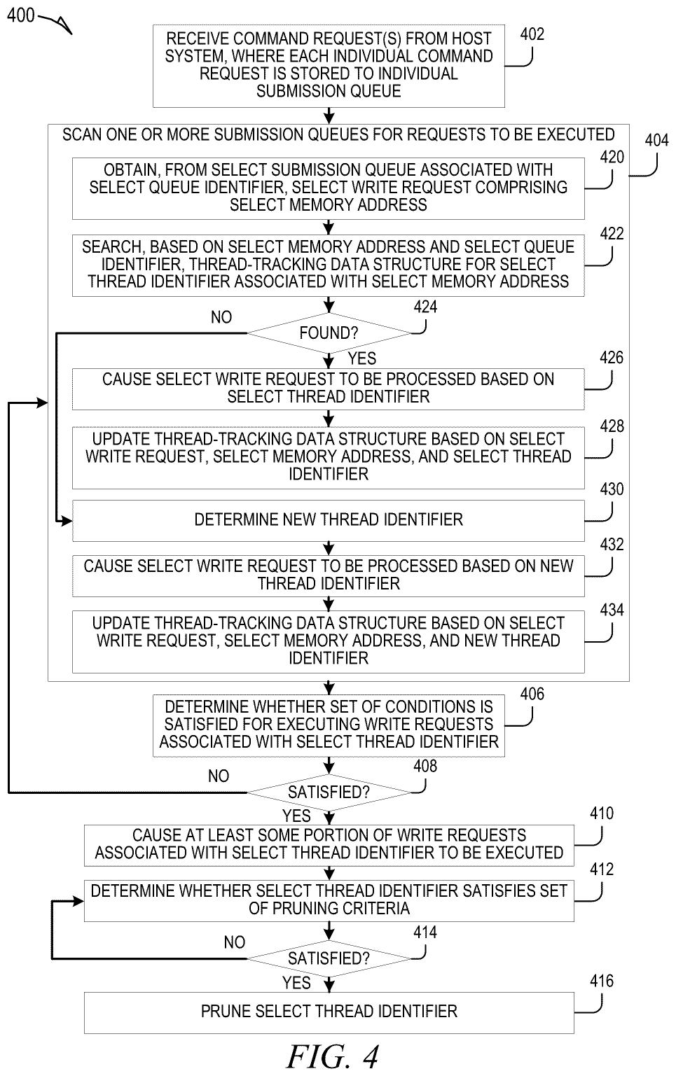

FIG. 4 is a flow diagram of an example method 400 for processing write requests on a memory system based on queue identifiers and thread identification associated with the write requests, in accordance with some embodiments of the present disclosure. Any of methods 400, 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, at least one of the methods 400, 500 is performed by the memory sub-system controller 115 of FIG. 1 based on the thread identifier-based write processor 113. Additionally, or alternatively, for some embodiments, at least one of the methods 400, 500 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible. For simplicity, in describing methods 400, 500, virtual threads are referred to as threads and virtual thread identifiers are referred to as thread identifiers.

Referring now to the method 400 of FIG. 4, the method 400 illustrates an example of processing write requests based on queue identifiers and thread identification associated with the write requests, in accordance with some embodiments.

At operation 402, a processing device (e.g., the processor 117 of the memory sub-system controller 115) receives a set of command requests from a host system (e.g., 120), where each individual command request in the set of command requests is stored to an individual submission queue of a memory system (e.g., the memory sub-system 110) associated with (e.g., that corresponds to) an individual queue identifier of the individual command request. For some embodiments, a command request received from the host system comprises a queue identifier (e.g., includes a QID tag) associated with the command request (e.g., based on the host-side submission queue from which the command request was sent).

Eventually, at operation 404, the processing device (e.g., the processor 117) scans one or more submission queues (e.g., scan each submission queue) of the memory system (e.g., the memory sub-system 110) for command requests to be executed. While scanning a given submission, the processing device performs operations 420 through 434. At operation 420, the processing device (e.g., the processor 117) obtains, from a select submission queue of the plurality of submission queues, a select write request that comprises a select memory address, where select submission queue is associated with a select queue identifier.

During operation 422, the processing device (e.g., the processor 117) searches, based on the select memory address and the select queue identifier, a thread-tracking data structure for a select thread identifier associated with the select memory address. The thread-tracking data structure can comprise a set of entries, where each entry in the set of entries can store a last memory address associated with a different pair of queue identifier and thread identifier. For some embodiments, operation 422 comprises, for an individual entry of the thread-tracking data structure associated with the select queue identifier, determining whether a last memory address stored in the individual entry precedes the select memory address. In doing so, the processing device can first search the thread-tracking data structure (e.g., array) based on a submission queue identifier (SQID) associated with the select write request, thereby limiting the initial search window of entries of the thread-tracking data structure searched for an existing thread identifier associated with the select write request. In response to determining that the last memory address precedes the select memory address, the processing device can determine that an individual thread identifier associated with the individual entry is the select thread identifier. In response to determining that no entry in the thread-tracking data structure associated with the select queue identifier is storing a last memory address that precedes the select memory address, the processing device can determine, for an individual entry of the thread-tracking data structure associated with another queue identifier (e.g., one or more queue identifies), whether a last memory address stored in the individual entry precedes the select memory address. For example, searching based on one or more other queue identifiers can comprise searching (e.g., checking) based on all other queue identifiers, or searching (e.g., checking) a threshold number of other queue identifiers (e.g., only check queue identifiers that are active or have history in the table, and randomly select from those). In response to determining that the second last memory address precedes the select memory address, the processing device can determine that an individual thread identifier associated with the individual entry is the select thread identifier.

At decision point 424, in response to finding the select thread identifier in the thread-tracking data structure by operation 422, method 400 proceeds to operation 426, otherwise method 400 proceeds to operation 430. At operation 426, the processing device (e.g., the processor 117) causes the select write request to be processed based on the select thread identifier. For some embodiments, operation 426 comprises causing write data from the select write request to be written to a data storage area of the memory device associated with the select thread identifier. For instance, the select write request can be added to a list of write requests (e.g., deferred or parked write requests) associated with the select thread identifier. At operation 428, the processing device (e.g., the processor 117) updates the thread-tracking data structure based on the select write request, the select memory address, and the select thread identifier. For instance, the thread-tracking data structure can update an entry associated with (e.g., indexed by) the select thread identifier found by operation 422 (or entry associated with [e.g., indexed by both] the select thread identifier and the select queue identifier of the select write request), and update the entry such that the entry stores a last memory address written to by the select write request (e.g., the LBA of the last memory location written to), where the last memory address is determined by the select memory address and a data length specified by the select write request.

During operation 430, the processing device (e.g., the processor 117) determines a new thread identifier to the select write request. Depending on the embodiment, operation 430 can comprise generating a new thread identifier for the select write request or assigning/allocating an unused thread identifier (that was previously used) for the select write request. At operation 432, the processing device (e.g., the processor 117) causes the select write request to be performed based on the new thread identifier (determined by operation 430). For some embodiments, operation 432 comprises causing write data from the select write request to be written to a data storage area of the memory device associated with the new thread identifier. For instance, the select write request can be added to a list of write requests (e.g., deferred or parked write requests) associated with the new thread identifier. Additionally, for operation 434, the processing device (e.g., the processor 117) updates the thread-tracking data structure based on the select write request, the select memory address, and the new thread identifier. For instance, the thread-tracking data structure can update an entry associated with (e.g., indexed by) the new thread identifier determined by operation 430 (or entry associated with [e.g., indexed by both] the new thread identifier and the select queue identifier of the select write request), and update the entry such that the entry stores a last memory address written to by the select write request (e.g., the LBA of the last memory location written to), where the last memory address is determined by the select memory address and a data length specified by the select write request.

After operation 404, at operation 406, the processing device (e.g., the processor 117) determines whether a set of conditions is satisfied for executing write requests from the list of write requests associated with the select thread identifier (or the new thread identifier). At decision point 408, in response to determining that the set of conditions is satisfied for executing write requests from the list of write requests associated with the select thread identifier by operation 406, method 400 proceeds to operation 410, otherwise method 400 returns to operation 404 where a next scan of submission queues is to be performed. For operation 410, the processing device (e.g., the processor 117) causes at least some portion of write requests from the list of write requests associated with the select thread identifier (or the new thread identifier) to be executed. For some embodiments, causing at least some portion of the write requests associated with the single thread identifier to be executed comprises the processing device causing at least one write request (e.g., all write requests) in the list of write requests to be executed. For some embodiments, the processing device causes a write request (e.g., a write request from a list) to be executed such that a thread identifier, associated with the write request, is stored on the memory device (e.g., 130, 140) in association with data written to a set of blocks of the memory device by the write request. This inclusion of the thread identifier can enable or facilitate garbage collection based on thread identifiers in accordance with various embodiments described herein. Additionally, where a memory device (e.g., 130, 140) comprises a plurality of superblocks that each comprise a plurality of blocks, the processing device can cause a plurality of write requests (e.g., from the list of write requests) to be executed such that data is written, by the plurality of write requests, to one or more superblocks in sequential configuration (e.g., organizational arrangement), such as a page stripe basis, a superblock basis, a physical-to-logical (P2L) layer basis, or on a 1/Nth deck basis.

Eventually, at operation 412, the processing device (e.g., the processor 117) determines whether the select thread identifier satisfies a set of pruning criteria. For example, the set of pruning criteria can include a criterion associated with a number limit of (virtual) threads, a criterion regarding a time period associated with a (virtual) thread, a criterion regarding how long a (virtual) thread is inactive, or some combination thereof. At decision point 414, in response to determining that the select thread identifier satisfies the set of pruning criteria, method 400 proceeds to operation 416, otherwise method 400 returns to operation 412. At operation 416, the processing device (e.g., the processor 117) prunes the select thread identifier. For example, operation 416 can comprise updating the thread-tracking data structure to remove one or more entries associated with the select thread identifier from the thread-tracking data structure.

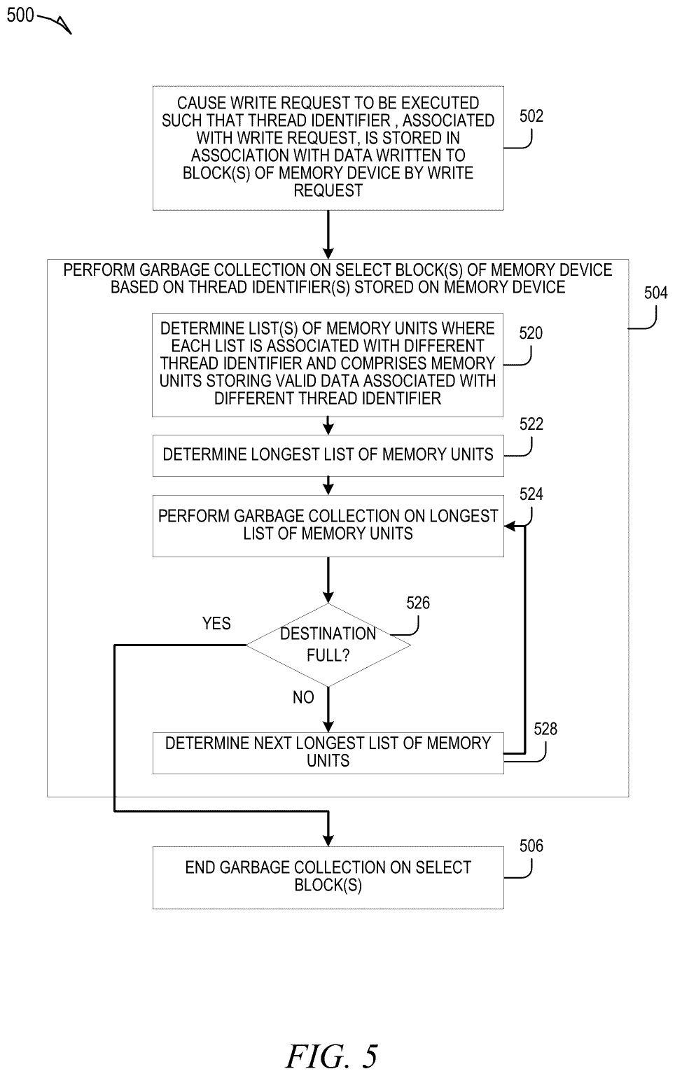

Referring now to the method 500 of FIG. 5, the method 500 illustrates an example of performing garbage collection based on (virtual) thread identifiers of write requests, in accordance with some embodiments. At operation 502, a processing device (e.g., the processor 117 of the memory sub-system controller 115) causes a write request (e.g., a deferred write request from a list) to be executed such that a thread identifier, associated with the write request, is stored on a memory device (e.g., 130, 140) in association with data written to a set of blocks of the memory device by the write request. Depending on the embodiment, a thread identifier can be stored on the memory device in association with data written to the set of blocks by including the thread identifier in metadata associated with the data written to the set of blocks, by storing the thread identifier in a separate (e.g., reserved) area of the memory device.

At operation 504, the processing device (e.g., the processor 117) performs on one or more select blocks of the memory device (e.g., 130, 140) based on thread identifiers stored on the memory device in association with the one or more select blocks. During operation 504, the processing device (e.g., the processor 117) performs one or more of operations 520, 522, 524, 526, 528. At operation 520, the processing device determines (e.g., generates) one or more lists of memory units (e.g., blocks or pages) from the one or more select blocks, where each list of the one or more lists is associated with a different thread identifier and comprises memory units (e.g., pages or blocks) storing valid data associated with the different thread identifier. Thereafter, at operation 522, the processing device (e.g., the processor 117) determines a longest list of memory units (e.g., blocks or pages) from the one or more lists of memory units determined at operation 520. Then, at operation 524, the processing device (e.g., the processor 117) performs a garbage collection operation on at least some portion (e.g., all) of the longest list of memory units. For some embodiments, valid data from memory units of the longest list is migrated to a collection of destination memory units (e.g., pages of a destination superblock) until the collection of destination memory units is full or there are no more memory units from the longest list left to migrate valid data from. If at operation 526, the processing device (e.g., the processor 117) determines that a collection of destination blocks (e.g., destination superblock) is not full, the method 500 proceeds to operation 528, where a next longest list of memory units is determined (e.g., identified) and the method 500 returns to operation 524. If, however, the processing device (e.g., the processor 117) determines that a collection of destination memory units (e.g., pages of a destination superblock) is full, the method 500 can proceed to operation 506, where the garbage collection on the one or more select blocks ends.

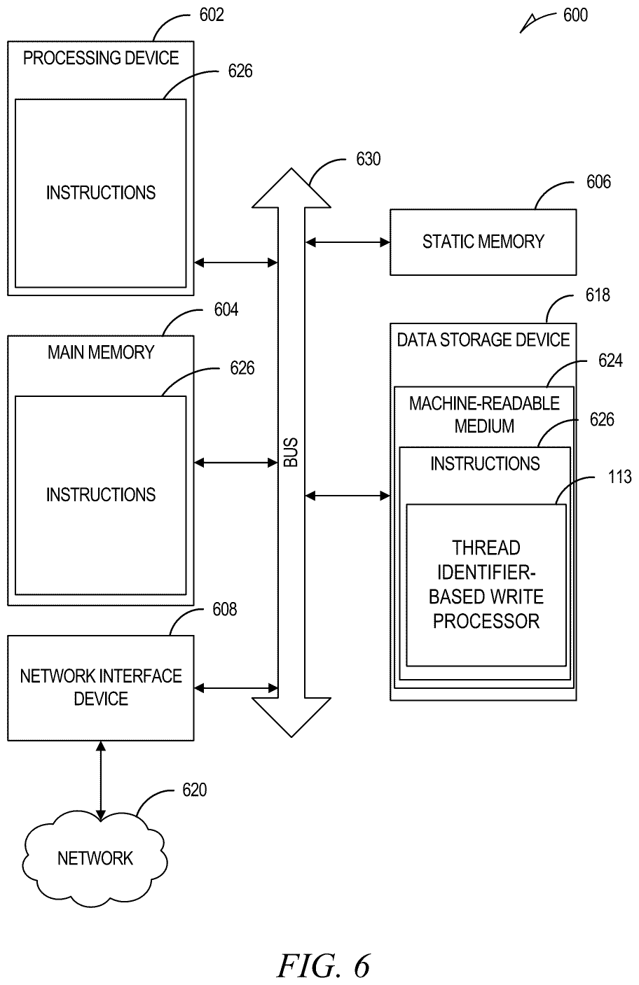

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage device 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage device 618, and/or main memory 604 can correspond to the memory sub-system 110 of FIG. 1.

In one embodiment, the instructions 626 include instructions to implement functionality corresponding to processing write requests based on queue identifiers and thread identification associated with the write requests as described herein (e.g., the thread identifier-based write processor 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of submission queues, each submission queue of the plurality of submission queues being associated with a corresponding queue identifier, each queue identifier being associated with at least one hardware processor core of a host system;
a memory device; and
a processing device, operatively coupled to the memory device, configured to perform operations comprising:
receiving a set of command requests from a host system, each individual command request in the set of command requests comprising an individual queue identifier and being stored to an individual submission queue of a plurality of submission queues associated with the individual queue identifier;
obtaining, from a select submission queue of the plurality of submission queues, a select write request that comprises a select memory address, the select submission queue being associated with a select queue identifier;
searching, based on the select memory address and the select queue identifier, a thread-tracking data structure for a select thread identifier associated with the select memory address; and
in response to finding the select thread identifier in the thread-tracking data structure:
causing the select write request to be processed based on the select thread identifier; and
updating the thread-tracking data structure based on the select write request, the select memory address, and the select thread identifier.

2. The system of claim 1, wherein the causing of the select write request to be performed based on the select thread identifier comprises:
causing write data from the select write request to be written to a data storage area of the memory device associated with the select thread identifier.

3. The system of claim 1, wherein the operations comprise:
in response to not finding the select thread identifier in the thread-tracking data structure:
determining a new thread identifier for the select write request;
causing the select write request to be performed based on the new thread identifier; and
updating the thread-tracking data structure based on the select write request, the select memory address, and the new thread identifier.

4. The system of claim 1, wherein the thread-tracking data structure comprises a set of entries, and wherein each entry in the set of entries stores a last memory address associated with a different pair of queue identifier and thread identifier.

5. The system of claim 1, wherein the searching of the thread-tracking data structure for the select thread identifier based on the select memory address and the select queue identifier comprises:
for an individual entry of the thread-tracking data structure associated with the select queue identifier, determining whether a last memory address stored in the individual entry precedes the select memory address; and
in response to determining that the last memory address precedes the select memory address, determining that an individual thread identifier associated with the individual entry is the select thread identifier.

6. The system of claim 1, wherein the searching of the thread-tracking data structure for the select thread identifier based on the select memory address and the select queue identifier comprises:
determining that no entry in the thread-tracking data structure associated with the select queue identifier is storing a first last memory address that precedes the select memory address; and
in response to determining that no entry in the thread-tracking data structure associated with the select queue identifier is storing the first last memory address that precedes the select memory address:
for an individual entry of the thread-tracking data structure associated with another queue identifier, determining whether a second last memory address stored in the individual entry precedes the select memory address; and
in response to determining that the second last memory address precedes the select memory address, determining that an individual thread identifier associated with the individual entry is the select thread identifier.

7. The system of claim 1, wherein the operations comprise:
determining whether the select thread identifier satisfies a set of pruning criteria; and
in response to determining that the select thread identifier satisfies the set of pruning criteria, updating the thread-tracking data structure to remove one or more entries associated with the select thread identifier from the thread-tracking data structure.

8. The system of claim 1, wherein the causing of the select write request to be performed based on the select thread identifier comprises:
adding the select write request to a list of write requests that is associated with the select thread identifier.

9. The system of claim 8, wherein the operations comprise:
determining whether a set of conditions is satisfied for executing write requests from the list of write requests associated with the select thread identifier; and
in response to determining that the set of conditions is satisfied for executing write requests from the list of write requests associated with the select thread identifier, causing at least some portion of write requests from the list of write requests associated with the select thread identifier to be executed.

10. At least one non-transitory machine-readable storage medium comprising instructions that, when executed by a processing device of a memory sub-system, cause the processing device to perform operations comprising:
receiving a set of command requests from a host system, the memory sub-system comprising a plurality of submission queues, each submission queue of the plurality of submission queues associated with a corresponding queue identifier, each queue identifier being associated with at least one hardware processor core of the host system, each individual command request in the set of command requests comprising an individual queue identifier and being stored to an individual submission queue of the plurality of submission queues associated with the individual queue identifier;
obtaining, from a select submission queue of the plurality of submission queues, a select write request that comprises a select memory address, the select submission queue being associated with a select queue identifier;
searching, based on the select memory address and the select queue identifier, a thread-tracking data structure for a select thread identifier associated with the select memory address; and
in response to not finding the select thread identifier in the thread-tracking data structure:
determining a new thread identifier for the select write request;
causing the select write request to be performed based on the new thread identifier; and
updating the thread-tracking data structure based on the select write request, the select memory address, and the new thread identifier.

11. The at least one non-transitory machine-readable storage medium of claim 10, wherein the causing of the select write request to be performed based on the new thread identifier comprises:
causing write data from the select write request to be written to a data storage area of a memory device of the memory sub-system, the data storage area being associated with the new thread identifier.

12. The at least one non-transitory machine-readable storage medium of claim 10, wherein the operations comprise:
in response to finding the select thread identifier in the thread-tracking data structure:
causing the select write request to be processed based on the select thread identifier; and
updating the thread-tracking data structure based on the select write request, the select memory address, and the select thread identifier.

13. The at least one non-transitory machine-readable storage medium of claim 10, wherein the thread-tracking data structure comprises a set of entries, and wherein each entry in the set of entries stores a last memory address associated with a different pair of queue identifier and thread identifier.

14. The at least one non-transitory machine-readable storage medium of claim 10, wherein the searching of the thread-tracking data structure for the select thread identifier based on the select memory address and the select queue identifier comprises:
for an individual entry of the thread-tracking data structure associated with the select queue identifier, determining whether a last memory address stored in the individual entry precedes the select memory address; and
in response to determining that the last memory address precedes the select memory address, determining that an individual thread identifier associated with the individual entry is the select thread identifier.

15. The at least one non-transitory machine-readable storage medium of claim 10, wherein the searching of the thread-tracking data structure for the select thread identifier based on the select memory address and the select queue identifier comprises:
determining that no entry in the thread-tracking data structure associated with the select queue identifier is storing a first last memory address that precedes the select memory address; and
in response to determining that no entry in the thread-tracking data structure associated with the select queue identifier is storing the first last memory address that precedes the select memory address:
for an individual entry of the thread-tracking data structure associated with another queue identifier, determining whether a second last memory address stored in the individual entry precedes the select memory address; and
in response to determining that the second last memory address precedes the select memory address, determining that an individual thread identifier associated with the individual entry is the select thread identifier.

16. The at least one non-transitory machine-readable storage medium of claim 10, wherein the operations comprise:
determining whether the select thread identifier satisfies a set of pruning criteria; and
in response to determining that the select thread identifier satisfies the set of pruning criteria, updating the thread-tracking data structure to remove one or more entries associated with the select thread identifier from the thread-tracking data structure.

17. The at least one non-transitory machine-readable storage medium of claim 10, wherein the causing of the select write request to be performed based on the select thread identifier comprises:
adding the select write request to a list of write requests that is associated with the select thread identifier.

18. The at least one non-transitory machine-readable storage medium of claim 17, wherein the operations comprise:
determining whether a set of conditions is satisfied for executing write requests from the list of write requests associated with the select thread identifier; and
in response to determining that the set of conditions is satisfied for executing write requests from the list of write requests associated with the select thread identifier, causing at least some portion of write requests from the list of write requests associated with the select thread identifier to be executed.

19. A method comprising:
receiving, at a memory sub-system, a set of command requests from a host system, the memory sub-system comprising a plurality of submission queues, each submission queue of the plurality of submission queues being associated with a corresponding queue identifier, each queue identifier being associated with at least one hardware processor core of the host system, each individual command request in the set of command requests comprising an individual queue identifier and being stored to an individual submission queue of the plurality of submission queues associated with the individual queue identifier; and
scanning, by a processing device of the memory sub-system, one or more submission queues of the plurality of submission queues for command requests to be executed, the scanning being configured to:
obtain, from a select submission queue of the plurality of submission queues, a select write request comprising a select memory address, the select submission queue being associated with a select queue identifier;
search, based on the select memory address and the select queue identifier, a thread-tracking data structure for a select thread identifier associated with the select memory address; and
in response to finding the select thread identifier in the thread-tracking data structure:
cause the select write request to be processed based on the select thread identifier; and
update the thread-tracking data structure based on the select write request, the select memory address, and the select thread identifier.

20. The method of claim 19, wherein the scanning being configured to:
in response to not finding the select thread identifier in the thread-tracking data structure:
determine a new thread identifier for the select write request;
cause the select write request to be performed based on the new thread identifier; and
update the thread-tracking data structure based on the select write request, the select memory address, and the new thread identifier.
